(19) United States
(12) Patent Application Publication
(10) Pub. No.: US 2017/0300899 A1
(43) Pub. Date: Oct. 19, 2017

(54) METHOD AND SYSTEM FOR SECURELY COMMUNICATING TRANSACTION INFORMATION USING ONE OR COMBINATION OF MULTIPLE CHANNELS

(71) Applicant: Sekhar Rao Balaga, Bangalore (IN)

(72) Inventor: Sekhar Rao Balaga, Bangalore (IN)

(21) Appl. No.: 15/490,018

(22) Filed: Apr. 18, 2017

(30) Foreign Application Priority Data
Apr. 18, 2016 (IN) 201641013485

(51) Int. Cl. G06Q 20/38; G06Q 20/32

(52) U.S. Cl. CPC G06Q 20/382; G06Q 20/3255

(57) ABSTRACT

Embodiments herein provide a method and system for communicating transaction information through an application on a user terminal without a data connection using one or combination of multiple channels. The method includes receiving a payment pre-processing request from the user terminal through one or more of a voice channel or SMS or USSD. The method includes receiving encrypted transaction information through SMS, USSD and voice channel or through one or more of the SMS, the USSD and the voice channel. The transaction information is communicated to the server without using dual tone multi frequency (DTMF). The method includes extracting transaction information by decrypting the transaction information. In an embodiment, the server extracts the transaction information by applying suitable decryption techniques. The method includes communicating the payment pre-processing request to the payment gateway a financial institution, a non-financial institution or the like. The method includes indicating the payment status to the user terminal.

### FIELD OF INVENTION

The embodiments herein relate to secure payment and transactions, and more particularly relates to a method and system for securely communicating transaction information using one or combination of multiple channels. The present application is based on, and claims priority from Indian Application Number 201641013485 filed on 18 Apr. 2016 the disclosure of which is hereby incorporated by reference.

### BACKGROUND OF INVENTION

The number of services provided by mobile network operators has considerably increased in the past few years. The convergence of mobile communication networks has enabled the creation of new value added services for mobile subscribers. When a user is using a communication device to initiate a payment for a service or a product, an electronic payment method is invoked where a credit card or debit card, wallets, loyalties, prepaid instruments and bank accounts, or the like is used to facilitate the payment.

When the user initiates a payment for a desired product or service, a payment request from the user is redirected to a merchant associated with the product. The merchant requests the user to provide a confirmation for payment. When the user provides the confirmation for the payment, the merchant redirects the payment request to a payment gateway for billing. The user inputs credentials and other associated security codes. The payment gateway processes the payment request after obtaining credentials of the user and the payment gateway informs the merchant to deliver the requested product to the user after processing the payment request.

In the above described system, the payment request is processed through an operator data connection or Wireless-Fidelity (Wi-Fi) connection between a user terminal and the payment gateway. In the existing system, the merchant (associated with the product/service) may obtain the details of the communication device which may include a mobile number and other identification data related to the user, while redirecting the purchase request to the payment gateway or while obtaining the information from the payment gateway to deliver requested product to the user.

The growing number of credit card fraud, limits the willingness of customers to use credit cards both online and offline. More and more users are not willing to enter their credit card information on websites as they are afraid of becoming victims of ID and credit card fraud.

Besides online fraud, happening after having entered credit card details online, additionally, cards may be lost or stolen or any other kind of fraud can happen. This is a general disadvantage of any kind of physical card, known since long ago, but not yet satisfactorily resolved.

The above information is presented as background information only to help the reader to understand the present invention. Applicants have made no determination and make no assertion as to whether any of the above might be applicable as Prior Art with regard to the present application.

### SUMMARY

The principal object of the embodiments herein is to provide a method and system for communicating transaction information from a user terminal using a one or combination of multiple channels without data connection.

Another object of the embodiments herein is to provide a method and system for communicating transaction information through one or more of short message service (SMS), unstructured supplementary service data (USSD), and voice channel to a server.

Another object of the embodiments herein is to provide a method and system for secured payment processing by encrypting the transaction information and communicating the encrypted transaction information through one or more of the SMS, the USSD and the voice channel to the server.

Another object of the embodiments herein is to provide a method and system for extracting transaction information by decrypting the transaction information at the server.

Another object of the embodiments herein is to provide a method and system for dynamically selecting a channel and corresponding transaction information to be encrypted in that channel.

Another object of the embodiments herein is to provide a method and system for indicating the channel and the associated encrypted transaction information in that channel to the server.

Another object of the embodiments herein is to provide a method and system for communicating the transaction information to the server without using dual tone multi frequency (DTMF).

Another object of the embodiments herein is to provide a method and system for decrypting the transaction information received through one or more channels and consolidating the transaction information for processing.

Another objective of the embodiments herein is to provide a method and system for dynamically updating the encryption/decryption algorithm between client and server while the data connection is enabled in the user terminal.

Another objective of the embodiments herein is to provide a method and system for updating selection of channel(s) between client and server while the data connection is enabled in the user terminal.

Accordingly the embodiments herein provide a method for securely communicating transaction information to a server without internet protocol (IP) connection by a user terminal. The method includes receiving the transaction information from a user. The method includes selecting at least one channel for communicating the transaction information to the server. Further, the method includes encrypting the transaction information on at least selected channel. Furthermore, the method includes communicating the encrypted transaction information through at least one selected channel to the server.

In an embodiment, the channel for communicating the transaction information includes at least one of: short message service (SMS), unstructured supplementary service data (USSD) and voice channel.

In an embodiment, the channel for communicating the identified transaction information includes one of: SMS, USSD and voice channel.

In an embodiment, encrypting the transaction information on at least one selected channel includes selecting at least one portion of the transaction information. The method includes dynamically selecting at least one channel for the identified at least one portion of the transaction information. The method includes receiving a communication from the server for encrypting the transaction information. The method includes encrypting the at least one portion of transaction information on the at least selected channel based on the communication received from the server.

In an embodiment, at least one portion of the transaction information is selected by segmenting the transaction information.

In an embodiment, the transaction information is communicated to the server without using dual tone multi frequency (DTMF).

Accordingly the embodiments herein provide a system for securely communicating transaction information to a server without internet protocol (IP) connection. The system includes a user terminal and a server. The user terminal is configured to receive the transaction information from a user. The user terminal is configured to select at least one channel for communicating the transaction information to the server. Further, the user terminal is configured to encrypt the transaction information on at least selected channel. Furthermore, the user terminal is configured to communicate the encrypted transaction information through at least one selected channel to the server. The server is configured to receive a payment pre-processing request from the user terminal. The server is configured to receive the encrypted transaction information from the user terminal through at least one channel. Further, the server is configured to extract the transaction information by decrypting the transaction information. Furthermore, the server is configured to communicate the transaction information to a payment gateway.

The server is configured to communicate the payment pre-processing request to the payment gateway, or a financial institution, or a non-financial institution or the like. In an embodiment, the server communicates the transaction information to the payment gateway or the financial institution, or the non-financial institution or the like for processing the payment. Further, the server is configured to indicate the payment status to the user terminal. In an embodiment, the server receives the payment status indication from the payment gateway, the financial institution, a non-financial institution or the like after the payment is processed. The server communicates the payment status to the user terminal informing success or failure of the transaction, through any of the channels such as the voice channel, SMS, USSD or in combination of the channels dynamically.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 illustrates a high level overview of a system for processing payment without data connection in which the encrypted transaction information is communicated using one or more channels, according to the embodiments as disclosed herein;

FIG. 2 illustrates a block diagram with various units in a user terminal, according to an embodiment as disclosed in the embodiments herein

FIG. 3 illustrates a block diagram with various units in a server, according to an embodiment as disclosed herein;

FIG. 4a is a flow diagram illustrating a method for communicating transaction information by a client using the one or more channels to a server, according to the embodiments as disclosed herein;

FIG. 4b is a flow diagram illustrating a method for processing payment by a server without data connection, according to the embodiments as disclosed herein;

FIG. 5 is a sequence diagram in which a client communicates the transaction information using the one or more channels without the data connection and a server processes a payment, according to the embodiments as disclosed herein; and

FIG. 6 illustrates a computing environment implementing a method and system for communicating encrypted transaction information using the one or combination of multiple channels, according to the embodiments as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Throughout the description, the terms data connection or Internet Protocol (IP) connection or wireless-fidelity (Wi-Fi) connection will have the same meaning and are used interchangeably in the description.

The embodiments herein achieve a method and system for communicating transaction information using one or combination of multiple channels. The method includes initiating a voice channel or short message service (SMS) or unstructured supplementary service data (USSD) by a client on the user terminal. The client can be present within an application on the user terminal or the client can be an application provided by a merchant. The method includes encrypting transaction information and selecting a channel for communicating the transaction information through a selected channel. In an embodiment, the transaction information is communicated using one or more channels which include SMS, USSD and voice channel or through any of the SMS, the USSD and the voice channel, wherein some portion of the transaction information is communicated through the SMS, other portion of the transaction information is communicated through USSD and the remaining portion of the transaction information is communicated through the voice channel.

Accordingly the embodiments herein provide a method implemented in a server. The method includes receiving a payment pre-processing request from the user terminal through a voice channel or SMS or USSD. The method includes receiving encrypted transaction information through SMS, USSD and voice channel or through any of the SMS, the USSD and the voice channel, wherein some portion of the transaction information is received through the SMS, other portion of the user portion of the transaction information is received through USSD and the remaining portion of the transaction information is received through the voice channel.

The method includes extracting transaction information by decrypting the transaction information received through the SMS, the USSD and the voice channel. In an embodiment, the server extracts the transaction information by applying suitable decryption techniques (which is known to the server apriori). Further, the method includes communicating the payment pre-processing request to the payment gateway, or a financial institution, or a non-financial institution or the like. In an embodiment, the server communicates the transaction information to the payment gateway for processing the payment.

Furthermore, the method includes indicating the payment status to the user terminal. In an embodiment, the server receives the payment status indication from the payment gateway, or the financial institution, or the non-financial institution or the like after the payment request is processed. The server communicates the payment status to the user terminal informing success or failure of the transaction.

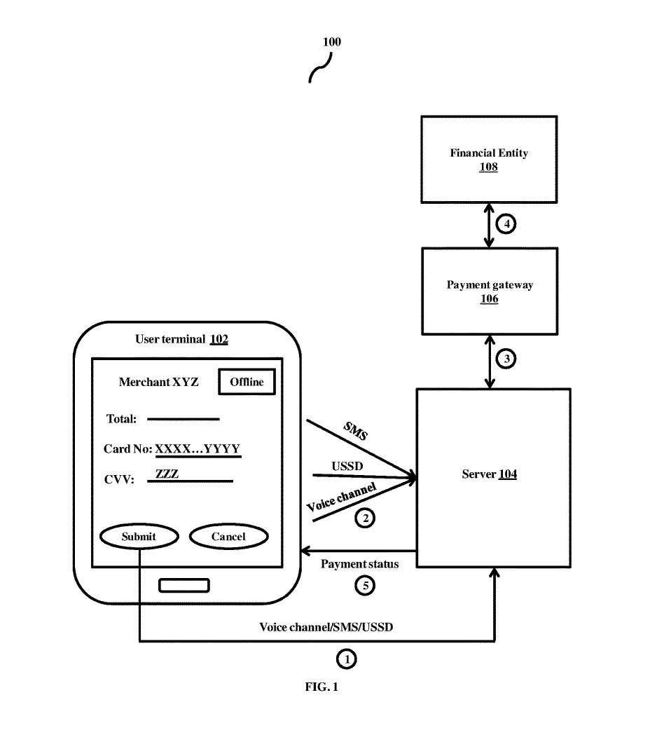

Referring now to the drawings and more particularly to FIGS. 1 through 6, where similar reference characters denote corresponding features consistently throughout the figures, there are shown preferred embodiments.

Unlike conventional systems, the proposed system provides a mechanism for processing payments without the data connection. The proposed method and system provides a mechanism in which the transaction information is encrypted and the channel is selected for communicating the encrypted transaction information to the server. The encrypted transaction information is sent either through the SMS, the USSD and the voice channel or through any combination thereof. Further, the transaction information is sent through the channel along with a header information to the server. The conventional method of payments is based on internet protocol (IP), which may be prone to connection losses in processing the payment. In the proposed method, the payment request is communicated through a conventional telephony such as a voice/signal call from the client on the user terminal to the server. Further, in the proposed method, the transaction information is communicated to the server without using DTMF.

FIG. 1 illustrates a high level overview of a system 100 for processing payment without data connection in which the encrypted transaction information is communicated using one or more channels, according to the embodiments as disclosed herein. As depicted in the FIG. 1, the system 100 includes a user terminal 102, a server 104, a payment gateway 106 and a financial entity 108.

The user terminal 102 may include, but are not limited to, a mobile phone, a tablet, a smart phone or any communication device or electronic device.

The server 104 is a third party server. In an embodiment, the server 106 can be network data center, or the like.

The server 104 receives the payment pre-processing request from the user terminal 102. Further, the server 104 communicates the payment pre-processing request to the payment gateway 106. In an embodiment, the server 104 can be present in a mobile network. In an embodiment, the server 104 communicates the payment processing request to a financial institution, a non-financial institution or the like.

In an embodiment, the server 104 processes the payment pre-processing request received through one or more interfaces including, charging gateways, financial services (for example: e-commerce, m-commerce and so on), mobile payment gateway, online banking, online wallet, mobile wallet and cash cards.

In an embodiment, the payment gateway 106 can be any third party payment gateway for processing the payment by communicating with any financial entity 108, an association network, acquirer, issuer, payment bank, aggregator or the like.

In an embodiment, the financial entity 108 can be a bank, or any financial institution, an association network, acquirer, issuer, payment bank, aggregator or the like which facilitates banking or other related services to its customers.

The various steps involved in communicating the transaction information using the one or more channels without data connection is as described herein. In the FIG. 1, the encircled numbers represent the steps involved in communicating the transaction information using the one or more channels. Initially, the client (which can be present inside the application or the application itself) on the user terminal 102 generates the payment pre-processing request for a service or product for which the user intends to proceed with the payment.

The user inputs the transaction information which includes merchant details (such as order identifier (ID) product ID), credit card credentials, debit card credentials, security codes, user ID, password credentials or the like. When the user inputs the information (i.e., the credit card credentials, debit card credentials, security codes, user ID, password credentials or the like) and clicks the submit button, the user terminal 102 initiates the voice channel or SMS or USSD to the server 102. In an embodiment, the user terminal 102 sends the payment pre-processing request to the mobile network through the voice channel or SMS or USSD.

In an embodiment, the payment pre-processing request is initiated through the application by providing a submit button option as an interface, which is displayed to the user on the application. When the user clicks on the submit button (which is provided to the user through an application programming interface (API)), the user terminal 102 initiates the voice channel or SMS or USSD and the payment processing request is redirected to the server 104 through the voice channel or SMS or USSD.

In an embodiment, the user may or may not be charged for initiating the payment pre-processing request.

When the payment pre-processing request is communicated to the server 104, the user terminal 102 encrypts the transaction information, where the transaction information is encrypted by adding random numbers, alphanumeric characters, special characters, special symbols or the like to the transaction information.

In an embodiment, when the payment pre-processing request is communicated to the server through the voice channel or the SMS or the USSD, the server 104 communicates with the client in the application on the user terminal 102 for dynamic selection of a technique/algorithm to be used for encrypting the transaction information. It should be noted that the algorithm for encrypting the transaction information can be dynamically decided by the server 104 and communicated to the client in the application on the user terminal 102 before encrypting the transaction information.

In an embodiment, the user terminal 102 communicates the transaction information to the server 104 through the SMS.

In an embodiment, the user terminal 102 communicates the transaction information to the server 104 through the USSD.

In an embodiment, the user terminal 102 communicates the transaction information to the server 104 through the voice channel.

In an embodiment, the user terminal 102 communicates the transaction information through one or more of the SMS, USSD and the voice channel, where a portion of the transaction information is communicated through the SMS, other portion of the user portion of the transaction information is communicated through USSD and the remaining portion of the transaction information is communicated through the voice channel. In an embodiment, the client in the application on the user terminal 102 communicates header information to the server 104 for indicating the transaction information communicated on different channels. The user terminal 102 communicates the transaction information without using DTMF.

The server 104 obtains the transaction information through the SMS, the USSD and the voice channel either individually or through the one or more of the SMS, the USSD and the voice channel from the user terminal 102.

In an embodiment, the server 104 validates the transaction information to determine whether a suitable encryption technique is used for encrypting the transaction information. After validating the encryption technique, the server 104 identifies a suitable decryption technique for decrypting the transaction information. The server 104 decrypts the transaction information obtained through the SMS, the USSD and the voice channel. In an embodiment, the server 104 determines the transaction information received through the channels (which are known only to the server 104 apriori).

In an embodiment, the server 104 extracts the transaction information by applying suitable decryption techniques (which are known only to the server 104 apriori). Further, the server 104 communicates the transaction information to the payment gateway 106 or the financial institution, the non-financial institution or the like for processing the payment request. The payment gateway 106 or the financial institution, the non-financial institution or the like receives the transaction information through the server 104 and communicates with the financial entity 108 for processing the payment. The financial entity 108 authenticates the user for processing the payment, for example by sending a onetime password (OTP) to the user terminal 102. In an example, the OTP can be sent to another user terminal based on the registered credit card or debit card details of the user.

In an embodiment, the OTP from the user terminal 102 can be communicated to the financial entity 108 dynamically through any of the channels such as the voice channel, the SMS or the USSD or in a combination of these channels.

In an embodiment, the user can be authenticated through one or more authentication parameters such as a MPIN, a voice biometric, a finger print, retina scan or the like. The authentication parameters can be communicated to the financial entity through any of the channels such as the voice channel, the SMS or the USSD or in a combination of these channels.

After successful authentication, the financial entity 108 confirms the payment deduction from user's account and communicates the payment deduction to the payment gateway 106. Further, the payment gateway 106 indicates the payment status to the server 104. The server 104 communicates the payment status to the user terminal 102. In an embodiment, the server 104 sends the payment status dynamically through any of the channels such as the voice channel, the SMS or the USSD or in a combination of these channels.

The FIG. 1 shows a limited overview of the system 100 but, it is to be understood that other embodiments are not limited thereto. The labels or names of the components in the system 100 are used only for illustrative purpose and does not limit the scope of the invention. Further, the system 100 can include any number of units or sub-units communicating among each other along with the other components. Likewise, the functionalities of one or more units can be combined by a single unit or can be distributed among each other in a manner different than described herein without departing from the scope of the invention.

Although the above described system 100 is explained using the client in the application provided by the merchant, it should be noted that the proposed system 100 can also be applicable in case where a single application can provide numerous services, where the services are integrated within the application. In such cases, the proposed system 100 can be applicable for each service provided by the application or can be applicable to only certain services provided by the application or in any combination thereof. In an embodiment, the client present in the application on the user terminal 102 can determine the encryption algorithm to be applied for encrypting the transaction information when the user intends to pay for different services. In an embodiment, the selection of encryption algorithm can different for different services. Also, the order in which the pattern of transaction information are delimited and the sent in channels can vary with services. Further, it should be noted that the proposed system 100 can readily implemented for applications provided by the payment gateways other than the applications provided by merchants.

The proposed system 100 can also be implemented on a wireless application protocol (WAP) portal, which can be accessible to the user terminal 102 through a WAP browser (for example: a web browser for the user terminal) on the user terminal 102.

It should be noted that the client in the application can update the encryption algorithm from the server 104, when the data connection is enabled on the user terminal 102. Further, the server 104 and the client can decide on any sequence/combination of channels for receiving transaction information.

In an embodiment, the client on the user terminal 102 dynamically selects the portion of transaction information and the channel to be used for sending the transaction information to the server 104. In case, where the user invokes a same service, the client on the user terminal may select a different portion of transaction information and selects a different channel to be used for sending the transaction information to the server 104.

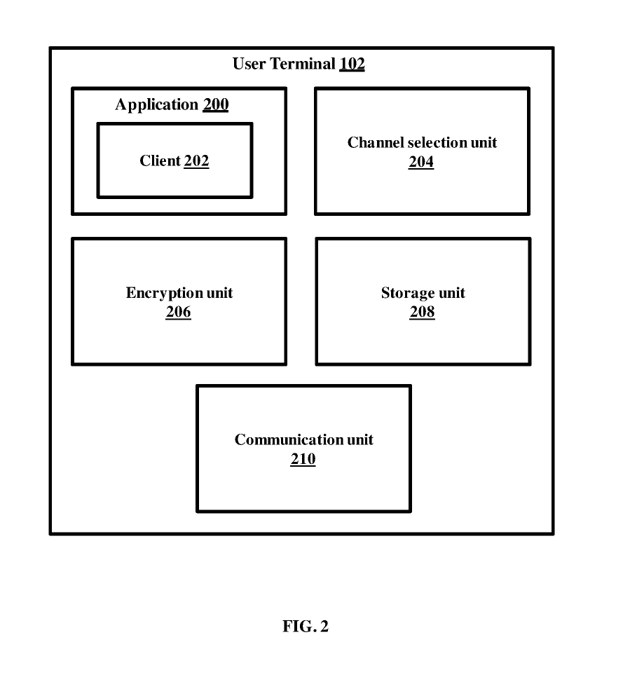

FIG. 2 illustrates a block diagram with various units in a user terminal 102, according to an embodiment as disclosed in the embodiments herein. As depicted in the FIG. 2, the user terminal 102 includes an application 200 with a client 202 embedded inside the application, a channel selection unit 204, an encryption unit 206, a storage unit 208 and a communication unit 210.

The application 200 can be any application provided by the merchant for providing one or more products or services to the customers. The client 202 can be present or embedded within the application 200 as shown in the FIG. 2. In some implementations, the client 202 can be present external to the application and can be capable of communicating with the application 200 and the server 104. In an embodiment, the client 202 can be the application 200 on the user terminal 102. The client 202 communicates with the server 104 for encrypting the transaction information. The client 202 receives communication from the server 104, the suitable technique for encrypting the transaction information. After receiving communication from the server, the client 202 encrypts the transaction information with the suitable technique (as decided by the server). In an embodiment, the client in the application on the user terminal 102 communicates header information to the server 104 for indicating the transaction information communicated on different channels.

The channel selection unit selects one or more channels for communicating the transaction information to the server 104. In an embodiment, the channel selection unit 204 selects SMS as the channel for communicating the transaction information to the server 104. In another embodiment, the channel selection unit 204 selects USSD as the channel for communicating the transaction information to the server 104. In another embodiment, the channel selection unit 204 selects USSD as the channel for communicating the transaction information to the server 104.

In an embodiment, the channel selection unit 204 selects a combination of SMS, USSD and the voice channel for communicating the transaction information to the server 104. It should be noted that the channel selection unit 204 can select one or more channels (i.e., SMS, USSD and voice channel) for communicating the transaction information to the server 104. The channel selection unit 204 may decide to select the channel based on the size of the transaction information. Further, the channel selection unit 204 communicates the selected channel to the encryption unit 206.

The encryption unit 206 encrypts the transaction information by adding random numbers, alphanumeric characters, special characters, special symbols or the like to the transaction information. The encryption unit 206 receives communication from the client 202 for the suitable technique (received from the server 104) to be used for encrypting the transaction information. The encryption unit 206 encrypts the transaction information on the selected channel.

The transaction information is encrypted on the SMS, USSD and the voice channel in case a combination of channels used for communicating the transaction information. The encryption unit 206 segments the transaction information into a plurality of segments or portions or chunks. The encryption unit 206 encrypts each of the segments of the transaction information of the selected channel. For example, a first segment of the transaction information is encrypted with SMS as the selected channel. A second segment of the transaction information is encrypted with USSD as selected channel. The third segment of the transaction information is encrypted with voice channel. It should be noted that the transaction information is communicated to the sever 104 without using DTMF.

In another example, the transaction information is encrypted on the SMS in case SMS is used as the channel for communicating the transaction information. Thus, the encryption unit 206 encrypts the transaction information on the selected channel (i.e., either SMS or USSD or voice channel, or the combination of these channels as described above).

The storage unit 208 may include one or more computer-readable storage media. The storage unit 208 may include non-volatile storage elements. Examples of such non-volatile storage elements may include magnetic hard disc, optical discs, floppy discs, flash memories, or forms of electrically programmable memories (EPROM) or electrically erasable and programmable (EEPROM) memories. In addition, the storage unit 208 may, in some examples, be considered a non-transitory storage medium. The term “non-transitory” may indicate that the storage medium is not embodied in a carrier wave or a propagated signal. However, the term “non-transitory” should not be interpreted that the storage unit 208 is non-movable. In some examples, the storage unit 208 can be configured to store larger amounts of information. In certain examples, a non-transitory storage medium may store data that can, over time, change (e.g., in Random Access Memory (RAM) or cache).

The communication unit 210 communicates the encrypted transaction information on the one or more channels to the server 104 without the IP connection or data connection. The communication unit 210 supports one or more suitable signaling protocols for communicating the encrypted transaction information on the one or more channels to the server 104. It should be noted that the transaction information is communicated to the sever 104 without using DTMF.

The FIG. 2 shows exemplary units of the user terminal 102 but it is to be understood that other embodiments are not limited thereon. In other embodiments, the user terminal 102 may include less or more number of units. Further, the labels or names of the units are used only for illustrative purpose and does not limit the scope of the invention. One or more units can be combined together to perform same or substantially similar function in the user terminal 102.

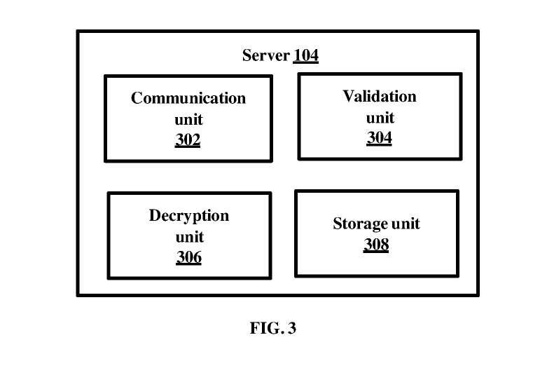

FIG. 3 illustrates a block diagram with various units in a server 104, according to an embodiment as disclosed herein. As depicted in the FIG. 3, the server 104 includes a communication unit 302, a validation unit 304, a decryption unit 306 and a storage unit 308.

In an embodiment, the communication unit 302 receives the encrypted transaction information through one or more channels such as SMS, USSD and the voice channel from the user terminal 102. Further, the communication unit 302 communicates the transaction information to the payment gateway 106 or the financial institution, the non-financial institution or the like for processing the payment request.

The validation unit 304 validates the transaction information to determine whether a suitable encryption technique is used for encrypting the transaction information.

The decryption unit 306 decrypts the transaction information by identifying a suitable decryption technique. The decryption unit 306 determines the transaction information received through one or more channels (which are known only to the decryption unit 306 a priori).

The storage unit 308 may include one or more computer-readable storage media. The storage unit 308 may include non-volatile storage elements. Examples of such non-volatile storage elements may include magnetic hard disc, optical discs, floppy discs, flash memories, or forms of electrically programmable memories (EPROM) or electrically erasable and programmable (EEPROM) memories. In addition, the storage unit 208 may, in some examples, be considered a non-transitory storage medium. The term “non-transitory” may indicate that the storage medium is not embodied in a carrier wave or a propagated signal. However, the term “non-transitory” should not be interpreted that the storage unit 308 is non-movable. In some examples, the storage unit 308 can be configured to store larger amounts of information. In certain examples, a non-transitory storage medium may store data that can, over time, change (e.g., in Random Access Memory (RAM) or cache).

The FIG. 3 shows exemplary units of the server 104 but it is to be understood that other embodiments are not limited thereon. In other embodiments, the server 104 may include less or more number of units. Further, the labels or names of the units are used only for illustrative purpose and does not limit the scope of the invention. One or more units can be combined together to perform same or substantially similar function in the server 104.

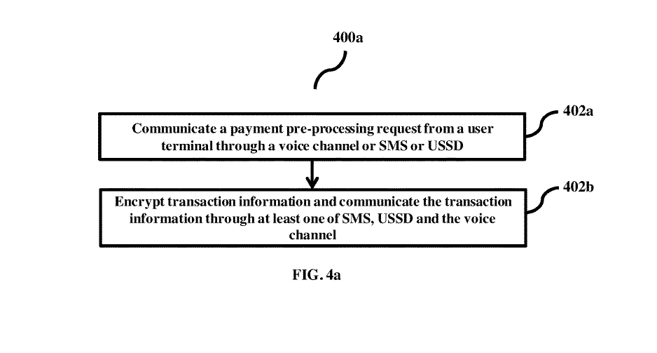

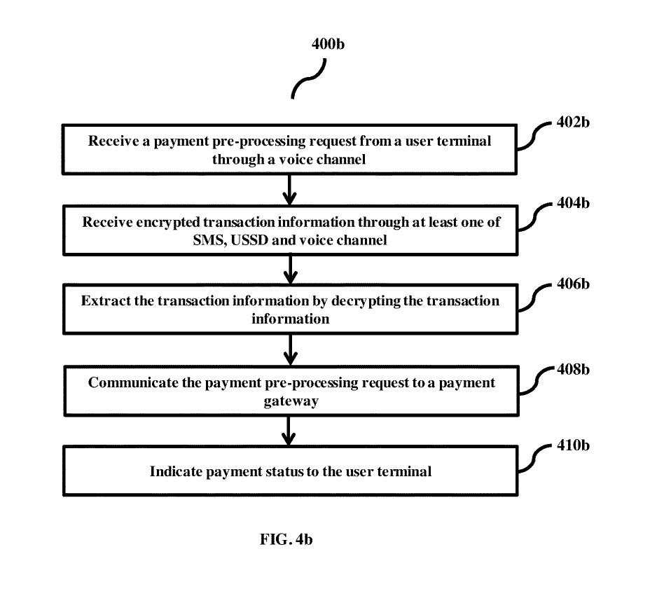

FIG. 4a is a flow diagram 400a illustrating a method for sending transaction information by a client using one or more channels to a server, according to the embodiments as disclosed herein. At step 402a, the method includes communicating the payment pre-processing request from the user terminal 102 through the voice channel or SMS or USSD. The method allows the communication unit 210 to communicating the payment pre-processing request from the user terminal 102 through the voice channel or SMS or USSD. In an embodiment, when the user inputs the transaction information (such as credit card details, debit card details or the like) in the application provided by the merchant and clicks the submit button, the user terminal 102 initiates the voice channel, or SMS or USSD to the server 102.

At step 404a, the method 400a includes encrypting transaction information and sends the transaction information through at least one of the SMS, the USSD and the voice channel. The method allows the encryption unit 206 to encrypt the transaction information and sends the transaction information through at least one of the SMS, the USSD and the voice channel. In an embodiment, the user terminal 102 communicates the transaction information through one or more of the SMS, USSD and the voice channel, where a portion of the transaction information is communicated through the SMS, other portion of the transaction information is communicated through USSD and the remaining portion of the transaction information is communicated through the voice channel. In an embodiment, the client within the application on the user terminal 102 communicates header information to the server 104 for indicating the transaction information sent on different channels.

The various actions, acts, blocks, steps, or the like in the flow diagram 400a may be performed in the order presented, in a different order or simultaneously. Further, in some embodiments, some of the actions, acts, blocks, steps, or the like may be omitted, added, modified, skipped, or the like without departing from the scope of the invention.

FIG. 4b is a flow diagram 400b illustrating a method for processing payment by a server without data connection, according to the embodiments as disclosed herein. At step 402b, the method includes receiving the payment pre-processing request from the user terminal 102 through the voice channel. The method allows the communication unit 302 to receive the payment pre-processing request from the user terminal 102 through the voice call. In an embodiment, the server 104 receives the payment pre-processing request using the mobile network through the voice channel or SMS or USSD.

At step 404b, the method includes receiving encrypted transaction information through SMS, USSD and the voice channel or through one or more of the SMS, the USSD and the voice channel, as decided by the client present in the application on the user terminal 102. The method allows the communication unit 302 to receive the encrypted transaction information through SMS, USSD and the voice channel or through one or more of the SMS, the USSD and the voice channel. In an embodiment, the server 104 receives the transaction information through one or more of the SMS, USSD and the voice channel or in a combination thereof, where some portion of the transaction information is received through the SMS, other portion of the transaction information is received through USSD and the remaining portion of the transaction information is received through the voice channel.

At step 406b, the method includes extracting the transaction information by decrypting the transaction information. The method allows the decryption unit 306 to extract the transaction information by decrypting the transaction information. In an embodiment, the server 104 extracts the transaction information by applying suitable decryption techniques (which are known only to the server 104 apriori).

At step 408b, the method includes communicating the payment pre-processing request to the payment gateway 106. The method allows the communication unit 302 to communicate the payment pre-processing request to the payment gateway 106. In an embodiment, the server 104 communicates the transaction information to the payment gateway 106. In an embodiment, the server 104 communicates the transaction information to the financial institution, a non-financial institution or the like for processing the payment. The payment gateway 106 receives the transaction information through the server 104 and communicates with the financial entity 108 for processing the payment request. The financial entity 108 authenticates the user for processing the payment, for example by sending a onetime password (OTP) to the user terminal 102. In an example, the OTP can be sent to another user terminal based on the credit card or debit card details of the user. In an embodiment, the OTP from the user terminal 102 can be communicated to the financial entity 108 dynamically through any of the channels such as the voice channel, the SMS or the USSD or in a combination of these channels.

In an embodiment, the user can be authenticated through one or more authentication parameters such as a MPIN, a voice biometric, a finger print, retina scan or the like. The authentication parameters can be communicated to the financial entity through any of the channels such as the voice channel, the SMS or the USSD or in a combination of these channels.

After successful authentication of the user, the financial entity 108 confirms the payment deduction from user's account and communicates the payment deduction to the payment gateway 106.

At step 410b, the method includes indicating the payment status to the user terminal 102. The method allows the communication unit 302 to indicate the payment status to the user terminal 102. In an embodiment, the server 104 receives the payment status indication from the payment gateway or from a financial institution (i.e., the financial entity 108, a non-financial institution or the like after the payment request is processed. The server 104 sends the payment status to the user terminal 102 indicating success or failure of the transaction. In an embodiment, the server 104 sends the payment status dynamically through any of the channels such as the voice channel, the SMS or the USSD or in a combination of these channels.

The various actions, acts, blocks, steps, or the like in the flow diagram 400b may be performed in the order presented, in a different order or simultaneously. Further, in some embodiments, some of the actions, acts, blocks, steps, or the like may be omitted, added, modified, skipped, or the like without departing from the scope of the invention.

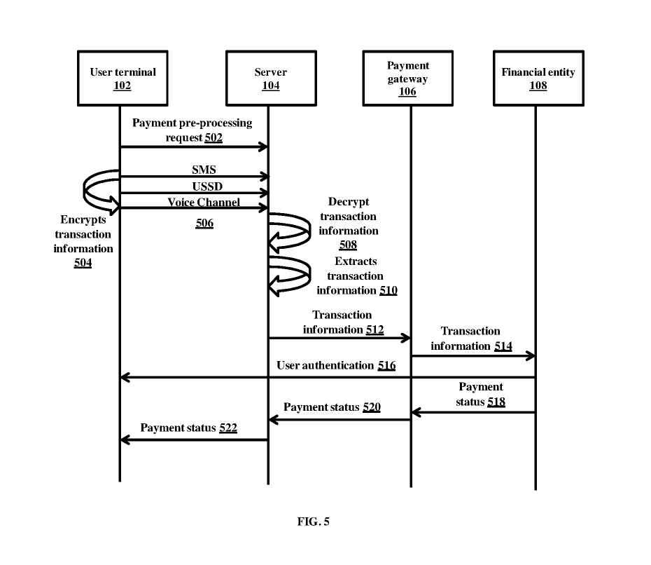

FIG. 5 is a sequence diagram in which a client sends the transaction information using one or more channels without data connection and a server processes a payment, according to the embodiments as disclosed herein. As depicted in the FIG. 5, the user terminal 102 communicates (502) the payment pre-processing request to the server 104. The user terminal 102 communicates the payment pre-processing request to the server 104 through the voice channel or SMS or USSD. After sending the payment pre-processing request to the server 104, the user terminal encrypts (504) the transaction information such as credit card details, debit card details or the like and communicates (506) the transaction information to the server through one or more of the SMS, the USSD and the voice channel or any through combination of the SMS, the USSD and the voice channel. The user terminal 102 communicates the transaction information to the server 102 without using DTMF.

The server 104 obtains the transaction information through one or more of the SMS, the USSD and the voice channel from the user terminal 102. Further, the server 104 decrypts (508) the transaction information obtained through one or more of the SMS, the USSD and the voice channel.

In an embodiment, the server 104 extracts (510) the transaction information by applying suitable decryption techniques (which is known only to the server 104 apriori). Further, the server 104 communicates (512) the transaction information to the payment gateway 106. In an embodiment, the server 104 communicates the transaction information to the financial institution, the non-financial institution or the like (i.e., without sending to the payment gateway 106) for processing the payment. The payment gateway 106 receives the transaction information through the server 104 and communicates (514) the transaction information to the financial entity 108 for processing the payment. The financial entity 108 authenticates (516) the user for processing the payment. After successful authentication, the financial entity 108 confirms the payment deduction from user's account and communicates (518) the payment confirmation to the payment gateway 106. Further, the payment gateway 106 indicates (520) the payment status to the server 104. The server 104 communicates (522) the payment status to the user terminal 102.

Although, the above mentioned description, described in light of financial sectors, it is to be understood for a person of ordinary skill in the art to be applicable for any of non-financial sectors or in the situations where high level of security is enforced.

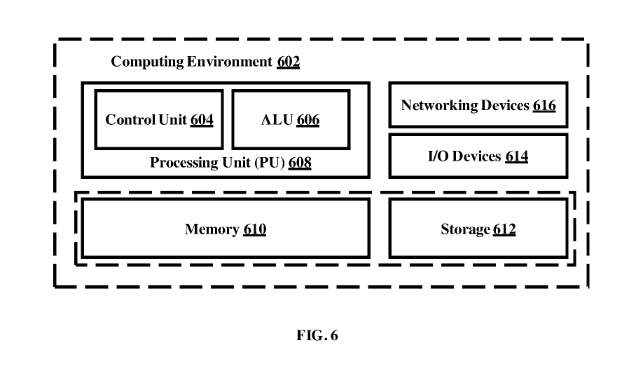

FIG. 6 illustrates a computing environment implementing a method and system for communicating encrypted transaction information using the one or combination of multiple channels, according to the embodiments as disclosed herein. As depicted the computing environment 602 comprises at least one processing unit 608 that is equipped with a control unit 604 and an Arithmetic Logic Unit (ALU) 606, a memory 610, a storage unit 612, plurality of networking devices 616 and a plurality Input output (I/O) devices 614. The processing unit 608 is responsible for processing the instructions of the algorithm. The processing unit 608 receives commands from the control unit in order to perform its processing. Further, any logical and arithmetic operations involved in the execution of the instructions are computed with the help of the ALU 606.

The overall computing environment 602 can be composed of multiple homogeneous and/or heterogeneous cores, multiple CPUs of different kinds, special media and other accelerators. The processing unit 604 is responsible for processing the instructions of the algorithm. Further, the plurality of processing units 604 may be located on a single chip or over multiple chips.

The algorithm comprising of instructions and codes required for the implementation are stored in either the memory unit 610 or the storage 612 or both. At the time of execution, the instructions may be fetched from the corresponding memory 610 and/or storage 612, and executed by the processing unit 608.

In case of any hardware implementations various networking devices 616 or external I/O devices 614 may be connected to the computing environment to support the implementation through the networking unit and the I/O device unit.

The embodiments disclosed herein can be implemented through at least one software program running on at least one hardware device and performing network management functions to control the elements. The elements shown in FIGS. 1 through 6 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for securely communicating transaction information to a server without internet protocol (IP) connection, by a user terminal, the method comprising:
receiving the transaction information from a user;
selecting at least one channel for communicating the transaction information to the server;
encrypting the transaction information on at least selected channel; and
communicating the encrypted transaction information through at least one selected channel to the server.

2. The method of claim 1, wherein the channel for communicating the transaction information includes at least one of: short message service (SMS), unstructured supplementary service data (USSD) and voice channel.

3. The method of claim 1, wherein encrypting the transaction information on at least selected channel comprises:
selecting at least one portion of the transaction information;
dynamically selecting at least one channel for the identified at least one portion of the transaction information;
receiving a communication from the server for encrypting the transaction information; and
encrypting the at least one portion of transaction information on the at least selected channel based on the communication received from the server.

4. The method of claim 3, wherein the at least one portion of the transaction information is selected by segmenting the transaction information.

5. The method of claim 1, wherein the transaction information is communicated to the server without using dual tone multi frequency (DTMF).

6. A system for securely communicating transaction information to a server without internet protocol (IP) connection, the system comprising:
a user terminal configured to:
receive the transaction information from a user;
select at least one channel for communicating the transaction information to the server;
encrypt the transaction information on at least selected channel; and
communicate the encrypted transaction information through at least one selected channel to the server.
a server configured to:
receive a payment pre-processing request from the user terminal;
receive the encrypted transaction information from the user terminal through at least one channel;
extract the transaction information by decrypting the transaction information; and
communicate the transaction information to a payment gateway.

7. The system of claim 6, wherein the user terminal is configured to communicate the transaction information through at least one of: short message service (SMS), unstructured supplementary service data (USSD) and voice channel.

8. The system of claim 6, wherein the user terminal is configured to encrypting the transaction information on at least selected channel by:
selecting at least one portion of the transaction information;
dynamically selecting at least one channel for the identified at least one portion of the transaction information;
receive a communication from the server for encrypting the transaction information
encrypting the at least one portion of transaction information on the at least selected channel based on the received communication from the server.

9. The system of claim 8, wherein the user terminal is configured to select the at least one portion of the transaction information by segmenting the transaction information.

10. The system of claim 6, wherein the user terminal is configured to communicate the transaction information to the server without using dual tone multi frequency (DTMF).

11. The system of claim 6, wherein the server is configured to receive the pre-processing request from the user terminal through one of: SMS, USSD and voice channel.

12. The system of claim 6, wherein the server is configured to extract the transaction information by decrypting the transaction information.
